(19) United States
(12) Patent Application Publication
(10) Pub. No.: US 2013/0093180 A1
(43) Pub. Date: Apr. 18, 2013

(54) DETACHABLE PLUG CONNECTION

(71) Applicant: Werner Kury, Mullheim (DE)

(72) Inventor: Werner Kury, Mullheim (DE)

(73) Assignee: NEOPERL GMBH, Mullheim (DE)

(21) Appl. No.: 13/592,417

(22) Filed: Aug. 23, 2012

(30) Foreign Application Priority Data
Oct. 18, 2011 (DE) 202011106817.3

(51) Int. Cl. F16L 37/133

(52) U.S. Cl. 285/88; 285/87

(57) ABSTRACT

A detachable plug connection having a connecting element connected to a sleeve-like receiving part, the interior of which receives a tubular plug-in part which carries an outer circumferential retaining rib, and having a securing element formed of hard-elastic material and has inwardly directed retaining edges, which spring out elastically, for engaging behind the retaining rib after insertion of the plug-in part, the retaining edges being connected together via resilient webs which converge in a V shape, and spring out by application of pressure to the converged web end regions of the resilient webs, such that the retaining edges disengage from the retaining rib. The connecting element and the securing element are connected integrally together to form a molding produced from hard-elastic material, and the connecting element and the securing element are connected together via deflectable resilient bars, in the extension of which at least one retaining edge is provided.

### CROSS-REFERENCE TO RELATED APPLICATIONS

This application claims the benefit of German Patent Application No. 102011106817.3, filed Oct. 18, 2011, which is incorporated herein by reference as if fully set forth.

### BACKGROUND

The invention relates to a detachable plug connection having a connecting element which is connected to a sleeve-like receiving part, the interior of which is intended for the introduction of a tubular plug-in part which carries a circumferential retaining rib on its outer circumference, and having a securing element which is comprised of hard-elastic material and has inwardly directed retaining edges, which can spring out elastically, for engaging behind the retaining rib after the plug-in part has been pushed in, said retaining edges being connected together via resilient webs which converge in a V shape, and which can spring out by application of pressure to the converged web end regions of the resilient webs, such that the retaining edges disengage from the retaining rib.

EP 605 801 B1 has already disclosed a detachable plug connection of the type mentioned in the introduction, said detachable plug connection serving as a hose coupling for connecting two line portions of a liquid line. The already known plug connection has a connecting element which is integrally connected to a sleeve-like receiving part. A tubular plug-in part can be introduced into the interior of the sleeve-shaped receiving part, said tubular plug-in part bearing a circumferential retaining rib on its outer circumference. In the coupling position of the already-known plug-in coupling, after the plug-in part is pushed into the receiving part, the retaining rib is engaged behind by inwardly directed retaining edges, which can spring out elastically, of a securing element. The retaining edges of the securing element, which is produced from hard-elastic material, are connected together via resilient webs which converge in a V shape, and which can spring out by application of pressure on the converged web end regions of the resilient webs, such that the retaining edges disengage from the retaining rib. To secure the position of the securing element which has been pushed into the connecting element, plate-like pushbuttons are integrally formed on the converged web end regions, which pushbuttons, in a position of use, protrude into in each case one passage opening, which is of complementary form, in the circumferential wall of the connecting element. It is a particular advantage that the connecting element which is connected to one line portion, the plug-in part which engages on the other line portion and the securing element can be formed as injection-molded plastics parts. The production of these plastics moldings which are coordinated with one another does however involve considerable outlay. Furthermore, there is the risk that excessive pressure loads which act on the connecting element and/or on the plug-in part transversely with respect to the longitudinal extent thereof lead to fracture of at least one of said plastic parts and to undesired leaks.

### SUMMARY

It is therefore the object in particular to provide a stable and loadable plug connection of the type mentioned in the introduction which can be produced with reduced costs.

This object is achieved according to the invention in that the connecting element and the securing element are connected integrally together to form a molding produced from hard-elastic material, and in that the connecting element and also the securing element are connected together via deflectable resilient bars, in the course or extension of which at least one retaining edge is provided.

In the plug connection according to the invention, the connecting element and the securing element are integrally connected to form a molding produced from hard-elastic material. For this purpose, the securing element and the connecting element are connected together via deflectable resilient bars, in the course or extension of which at least one retaining edge is provided. It is the case in the plug connection according to the invention, too, that the retaining edges are connected together by resilient webs which converge in a V shape. Through the application of pressure to the converged web end regions of said resilient webs, it is possible for the deflectable resilient bars between the connecting element and securing element to spring out such that the retaining edges disengage from the retaining rib. Here, the resilient bars may be designed to be stable and loadable enough to connect the line portions together in the axial direction practically without play. Since it is possible to dispense with a separate securing element and therefore a further complete plastic injection-molded part, the production of the plug connection according to the invention is possible with reduced outlay.

To additionally promote the high loadability of the plug connection according to the invention, it is advantageous for the receiving part and/or the plug-in part to be produced from metal material and in particular from brass.

Receiving parts and/or plug-in parts produced from metal material can also be produced cheaply if appropriate in large quantities if the receiving part and/or the plug-in part are produced as turned parts.

The simple and cheap production of the plug connection according to the invention is promoted if the molding including the connecting element and the securing element, which is connected integrally thereto, is produced from a hard-elastic plastics material and in particular as an injection-molded plastics part.

A preferred embodiment of the invention provides that the connecting element is formed in a sleeve-like manner, that the receiving part has at least one stop on its outer circumferential side, and that the receiving part is insertable into the sleeve interior of the connecting element until a counter-stop which is provided on the inner circumferential side in the sleeve interior of the connecting element and is preferably in the form of an annular shoulder or annular flange limits the insertion path of the receiving part at its stop.

To be able to connect the plug connection according to the invention in a simple manner to a line portion and in particular to a flexible hose line, it is advantageous that the end region of the receiving part that is remote from the insertion part and/or that end region of the insertion part that is remote from the receiving part to be in the form of a hose nipple, onto which the hose end of a preferably flexible hose line can be pushed. Here, it is also possible for a flexible hose line to engage only on the receiving part or on the insertion part, while the other constituent part of the plug connection according to the invention is formed for example as an immovably held appliance connector. An embodiment is however preferable in which the hose end of a flexible hose line is held both on the receiving part and also on the plug-in part.

To make the hose coupling realized via the plug connection according to the invention as leak-tight as possible, it is advantageous for at least one annular seal to provide sealing between the receiving part and the plug-in part inserted into the latter.

In this regard, a preferred embodiment of the invention provides that an annular groove is provided on the inner circumferential side in that subregion of the receiving part that rests against the plug-in part, a sealing ring that encloses the plug-in part in a sealed manner on the outer circumferential side being provided in said annular groove.

Simple handling of the plug connection according to the invention is further promoted if a finger button for manually applying pressure is integrally formed on the converged web end regions of the resilient webs. This finger button can be formed such that the handling of the plug connection according to the invention is self-explanatory even without written instructions for use.

### BRIEF DESCRIPTION OF THE DRAWINGS

Refinements of the invention will emerge from the description in conjunction with the figures. A preferred embodiment of the invention will be explained in more detail below on the basis of the drawing, in which:

FIG. 1 shows, in longitudinal section, a plug connection designed for connecting the flexible line portions of a hose line, wherein said plug connection has substantially a connecting element, a receiving part held therein, a plug-in part that can be introduced into the receiving part, and a securing element,

FIG. 2 shows the connecting element, connected to the securing element to form a single-piece molding, of the plug connection from FIG. 1 in a perspective illustration as viewed from its introduction opening,

FIG. 3 shows the molding comprised of connecting element and securing element from FIG. 2 in a perspective illustration as viewed from below,

FIG. 4 shows the plug-in part, the receiving part, the connecting element integrally connected to the securing element, and the hose end held on the receiving part, of the plug connection from FIG. 1 in an exploded, partially sectional and perspective component illustration,

FIG. 5 shows the constituent parts of the plug connection from FIGS. 1 and 4 in an exploded component illustration, wherein in this case the receiving part has already been introduced into the molding comprised of the connecting element and the securing element integrally connected thereto,

FIG. 6 shows the constituent parts of the plug connection from FIGS. 1 and 4 to 5 in a partially sectional perspective view, wherein the hose end of a flexible hose line engages on the receiving part which is held in the molding comprised of the connecting element and the securing element, while the plug-in part is still arranged outside the coupling position of the plug connection,

FIG. 7 shows the plug connection from FIGS. 1 and 4 to 6 in the coupling position of its constituent parts,

FIG. 8 shows the plug connection from FIGS. 1 and 4 to 7 in a plan view of the plug-in part, which has been pushed only in regions into the receiving part,

FIG. 9 shows the plug connection from FIGS. 1 and 4 to 8 in a partially sectional perspective view as per FIG. 8,

FIG. 10 shows the plug connection from FIGS. 1 and 4 to 9 in a longitudinal section through section plane X-X in FIG. 8,

FIG. 11 shows the plug connection from FIGS. 1 and 4 to 10 in a plan view of the plug-in part which has been pushed into the coupling position,

FIG. 12 shows the plug connection from FIGS. 1 and 4 to 11 in a partially sectional perspective view in the coupling position shown in FIG. 11, and

FIG. 13 shows the plug connection from FIGS. 1 and 4 to 12 in a longitudinal section through section plane XIII-XIII from FIG. 11.

### DETAILED DESCRIPTION OF THE PREFERRED EMBODIMENTS

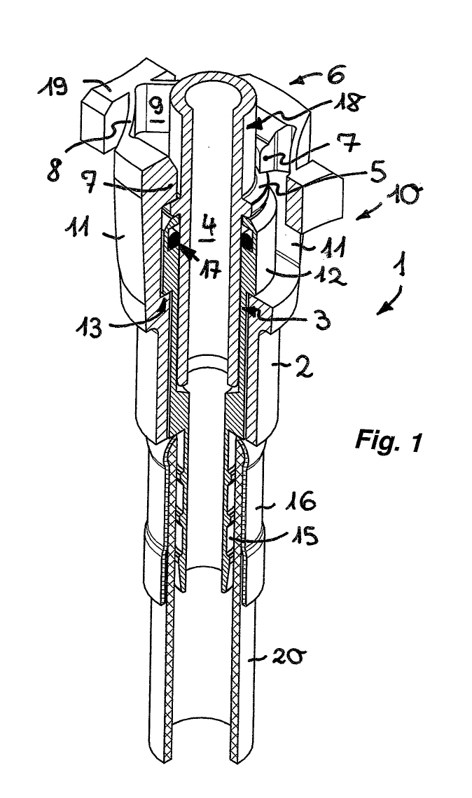

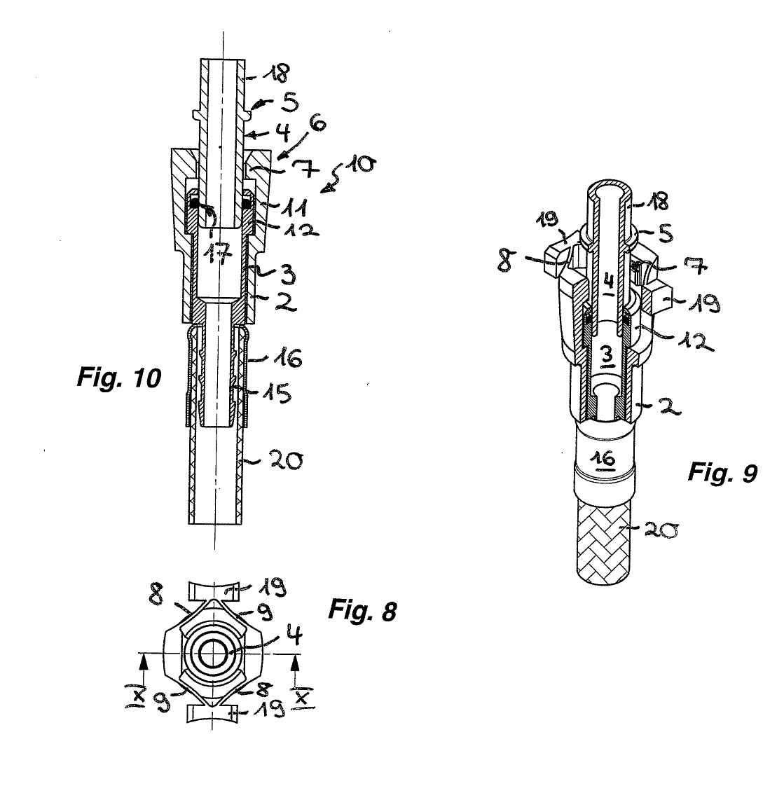

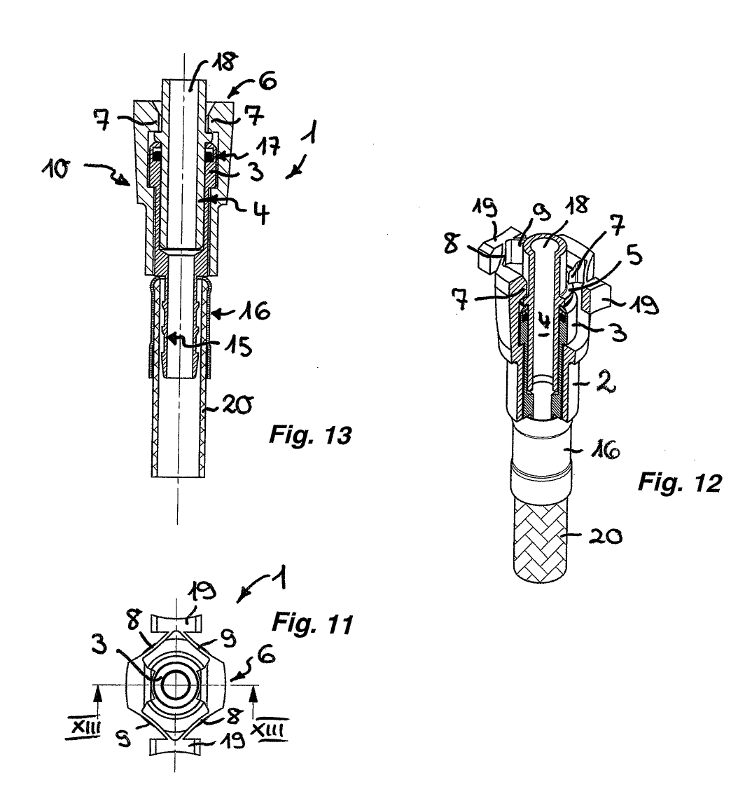

FIGS. 1 to 13 illustrate a detachable plug connection 1 which serves for the coupling connection of two line portions. The plug connection 1 is provided preferably for the coupling connection of two line portions of a liquid line and in particular of a sanitary water line.

The plug connection 1 has a connecting element 2 which is connected to a sleeve-like receiving part 3. A tubular plug-in part 4 which carries a circumferential retaining rib 5 on its tube outer circumference can be introduced into the interior of the sleeve-like receiving part 3. The plug connection 1 also has a securing element 6 which has inwardly directed retaining edges 7 which are designed for engaging behind the retaining rib 5 after the tubular plug-in part 4 has been pushed into the receiving part 3.

Whereas the receiving part 3 is connected, at its end remote from the plug-in part 4, to one line portion, the tubular plug-in part 4 engages with its end region remote from the receiving part 3 on the other line portion. Here, one line portion may serve for example as an appliance connector of a water-conducting or water-consuming appliance, while the other line portion forms the water supply or drain. At least one of said line portions and preferably both line portions are in the form of flexible hose lines 20 wrapped in particular with a metal mesh.

The retaining edges 7 which engage on the retaining rib 5 of the plug-in part 4 preferably in pairs on opposite sides are connected together via resilient webs 8, 9 which converge in a V shape, and can spring out by manual application of pressure to the converged web end regions of the resilient webs 8, 9, such that the retaining edges 7 disengage from the retaining rib 5.

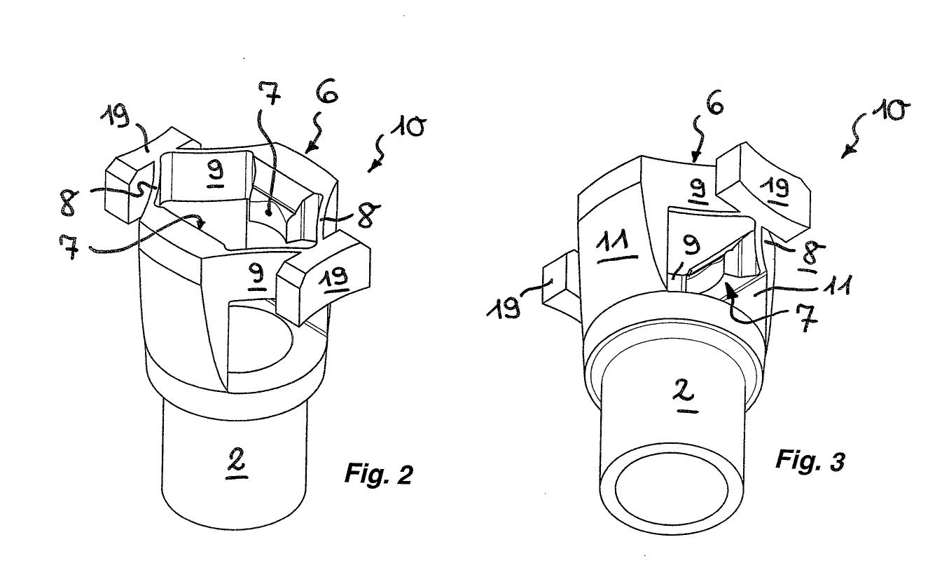

In the component illustrations of FIGS. 2 and 3, it is clear that the connecting element 2 and the securing element 6 are connected integrally together to form a molding 10 produced from hard-elastic material. For this purpose, the connecting element 2 and the securing element 6 are connected together via deflectable resilient bars 11, in the course or extension of which at least one retaining edge 7 is provided.

In the plug connection 1 illustrated here, the connecting element 2 and the securing element 6 are integrally connected to form a molding 10 produced from hard-elastic material. For this purpose, the securing element 6 and the connecting element 2 are connected together via deflectable resilient bars 11, in the course or extension of which at least one retaining edge 7 is provided. The retaining edges 7 of the plug connection 1 are connected together by means of resilient webs 8, 9 which converge in a V shape. Through the application of pressure to the converged web end regions of said resilient webs 8, 9, it is possible for the deflectable resilient bars 11 between the connecting element and securing element 2, 6 to spring out such that the retaining edges 7 disengage from the retaining rib 5. Here, the resilient bars 11 may be designed to be stable and loadable enough to connect the line portions together in the axial direction practically without play. Since it is possible to dispense with a separate securing element 6 and therefore a further complete injection-molded plastics part, the production of the plug connection 1 is possible with reduced outlay.

In order that the plug connection 1 can also effectively accommodate transverse forces acting transversely with respect to its longitudinal extent without resulting in material fractures and undesired leaks, the sleeve-like receiving part 3 and/or the tubular plug-in part 4 are produced from metallic material and in particular from brass. Here, cheap mass production of the metal parts is promoted if the receiving part 3 and/or the plug-in part 4 are produced as turned parts.

By contrast, the molding 10 formed of connecting element 2 and securing element 6, which is connected integrally thereto, may be produced from a hard-elastic plastic material and in particular as an injection-molded plastic part. The receiving part 3 has, on its end region facing the plug-in part 4 and on the outer circumferential side, a cross-sectional widening 12. Here, the receiving part 3 can be inserted, past the retaining edges 7 of the securing element 6, into the sleeve interior of the sleeve-like connecting element 2 until a stop, in this case in the form of an annular shoulder 13 on the outer circumferential side, of the receiving part 3 abuts against an annular shoulder 14 which is provided on the connecting element 2 and which serves as a counter-stop. In this coupling position shown for example in FIGS. 1 and 6, the connection part 3 protrudes with its end region, in this case in the form of a hose nipple 15, beyond that face end of the connecting element 2 that is remote from the plug-in part 4. The hose end 20 of a hose line, which is in this case reinforced for example by a metal mesh or the like, is pushed onto that end region of the connection part 3 which is in the form of a hose nipple 15, and said hose end is secured there by a crimp sleeve 16 which surrounds the hose end 20 and presses it onto the hose nipple 15. The receiving part 3 is held on the connecting element 2, so as to be immovable in the axial direction, by the stop on the receiving part 3 and the hose end 20 which is secured on the hose nipple 15 thereof.

At least one annular seal provides sealing between the receiving part 3 and the plug-in part 4 which is inserted into the latter in the coupling position. For this purpose, the receiving part 3 preferably has, in the region of its cross-sectional widening 12, an annular groove in which is held a sealing ring 17 which, in the coupling position of the plug connection 1, bears sealingly against the plug-in part 4.

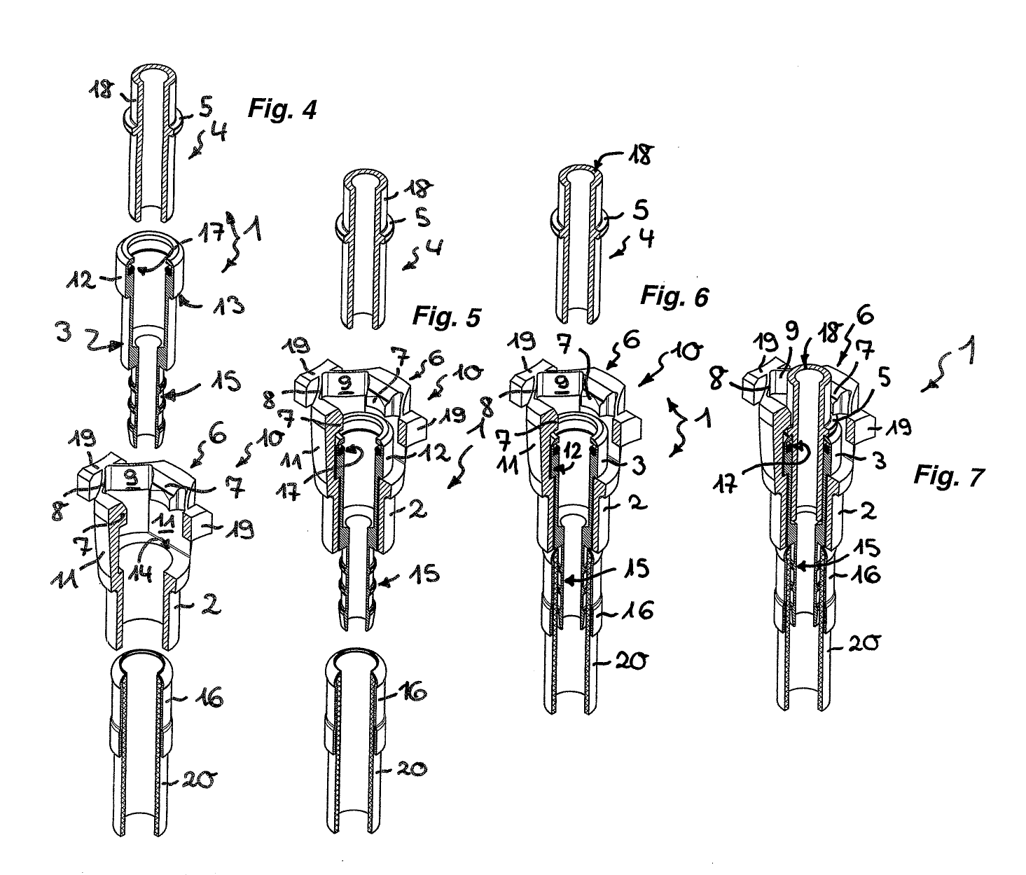

Viewing FIGS. 4 to 7 or FIGS. 8 to 13 together, it is clear that the plug-in part 4 can be pushed into the interior of the receiving part 3 until the retaining rib 5 provided on the plug-in part 4 is engaged behind by the retaining edges 7 provided in the extension of the resilient bars 11. In said coupling position of the plug connection 1, the retaining rib 5 provided on the plug-in part 4 is held so as to be immovable in the axial direction, but so as to be rotatable, between the adjacent end surface of the receiving part 3 at one side and the retaining edges 7 at the other side. It can be seen in FIGS. 4 to 7 that that end region 18 of the plug-in part 4 that is remote from the receiving part 3 may also be in the form of a hose nipple onto which a hose end of a flexible hose line (not illustrated in any more detail here) can be pushed and preferably likewise secured by means of a crimp sleeve.

By application of pressure to the converged ends of the resilient webs 8, 9, the resilient bars 11 can deflect and the retaining edges 7 arranged in the extension thereof can spring out such that the retaining edges 7 disengage from the retaining rib 5 and the plug-in part 4 of the plug connection 1 can be at least temporarily detached again from the connecting element 2 and from the receiving part 3 which extends around it.

### LIST OF REFERENCE NUMERALS

1 Plug connection
2 Connecting element
3 Receiving part
4 Plug-in part
5 Retaining rib
6 Securing element
7 Retaining edges
8 Resilient web
9 Resilient web
10 Molding (formed of connecting element 2 and securing element 6)
11 Resilient bars (between connecting element 2 and securing element 6)
12 Cross-sectional widening (of the receiving part 3)
13 Annular shoulder (on receiving part 3)
14 Annular shoulder (on connecting element 2)
15 Hose nipple
16 Crimp sleeve
17 Sealing ring
18 End region (in the form of a hose nipple on plug-in part 4)
19 Pushbutton
20 Hose end

1. Detachable plug connection (1) comprising a connecting element (2) which is connected to a sleeve-like receiving part (3), an interior of which is intended for introduction of a tubular plug-in part (4) which carries a circumferential retaining rib (5) on an outer circumference thereof, and having a securing element (6) which is comprised of hard-elastic material and has inwardly directed retaining edges (7), which can spring out elastically, for engaging behind the retaining rib (5) after the plug-in part (4) has been pushed in, said retaining edges (7) being connected together via resilient webs (8, 9) which converge in a V shape, and which can spring out by application of pressure to converged web end regions of the resilient webs (8, 9), such that the retaining edges (7) disengage from the retaining rib (5), the connecting element (2) and the securing element (6) are connected integrally together to form a moulding (10) produced from hard-elastic material, and the connecting element (2) and the securing element (6) are connected together via deflectable resilient bars (11), in a course or extension of which at least one of the retaining edges (7) is provided.

2. The plug connection according to claim 1, wherein at least one of the receiving part (3) or the plug-in part (4) are produced from metal material.

3. The plug connection according to claim 2, wherein at least one of the receiving part (3) and the plug-in part (4) are produced as rotating parts.

4. The plug connection according to claim 1, wherein the molding (10) formed of the connecting element (2) and the securing element (6), which is connected integrally thereto, is produced from a hard-elastic plastic material.

5. The plug connection according to claim 1, wherein the connecting element (2) is formed in a sleeve-like manner, the receiving part (3) has a stop on an outer circumferential side thereof, and the receiving part (3) is insertable into the sleeve interior of the connecting element (2) until a counter-stop which is provided on an inner circumferential side in the sleeve interior of the connecting element (2) and is in the form of an annular shoulder or annular flange limits an insertion path of the receiving part (3) at the stop.

6. The plug connection according to claim 1, wherein at least one of an end region of the receiving part (3) that is remote from the plug-in part (4) or an end region of the plug-in part (4) that is remote from the receiving part (3) is a hose nipple (15; 18), onto which the hose end (20) of a hose line can be pushed.

7. The plug connection according to claim 1, wherein at least one annular seal provides sealing between the receiving part (3) and the plug-in part (4) inserted into the latter.

8. The plug connection according to claim 1, wherein an annular groove is provided on an inner circumferential side in a subregion of the receiving part (3) that rests against the plug-in part (4), a sealing ring that encloses the plug-in part in a sealed manner on an outer circumferential side being provided in said annular groove.

9. The plug connection according to claim 1, wherein a finger button (19) for manually applying pressure is integrally formed on the converged web end regions of the resilient webs (8, 9).

10. The plug connection according to claim 4, wherein the moulding (10) is an injection-moulded plastics part.
